(19) United States
(12) Patent Application Publication
(10) Pub. No.: US 2009/0109223 A1
(43) Pub. Date: Apr. 30, 2009

(54) System and Method for Virtual Journey Futuring

(75) Inventors: James P. Schalla, Edmonds, WA (US); Calsee N. Robb, Seattle, WA (US); William A. Harkness, Everett, WA (US); Buddy L. Sharpe, Mill Creek, WA (US); Heidi J. Kneller, Bellevue, WA (US)

Correspondence Address: HARNESS DICKEY & PIERCE, PLC, P.O. BOX 828, BLOOMFIELD HILLS, MI, 48303, US

(73) Assignee: The Boeing Company, Chicago, IL (US)

(21) Appl. No.: 11/927,368

(22) Filed: Oct. 29, 2007

(51) Int. Cl. G06T 15/00; A47C 7/00; B64C 7/00

(52) U.S. Cl. 345/427; 244/129.1; 297/217.1; 297/217.3

(57) ABSTRACT

A system for displaying at least one virtual future journey to at least one passenger onboard a mobile platform (such as a train, marine vessel, aircraft or automobile) is provided. The system includes a display device that displays the virtual future journey. The system further includes a journey futuring control module that generates the journey data that includes at least one future journey for the passenger. The future journey is selected from the group that includes a journey from the mobile platform to a baggage claim, a journey from the baggage claim to a transportation means, a journey via the transportation means to a destination, and combinations thereof. The system further includes a graphical user interface control module that displays the future journey for the passenger on the display device to enable the passenger to virtually view the future journey.

### FIELD

The present disclosure relates generally to virtual travel prior to an actual journey, and more particularly to a system and method for virtual journey futuring.

### BACKGROUND

The statements in this section merely provide background information related to the present disclosure and may not constitute prior art.

Many mobile platforms (such as trains, ships, aircraft and automobiles) employ entertainment systems adjacent to a passenger seating surface to occupy the passenger during the travel of the mobile platform. For example, in the case of a commercial aircraft, a passenger cabin may be equipped with one or more in-flight entertainment systems. These in-flight entertainment systems may be coupled to a seat back disposed in front of the passenger such that while seated, the passenger may be occupied via the in-flight entertainment system positioned on the seat back in front of them.

Generally, the in-flight entertainment system is used to occupy passengers during long flights. Thus, the in-flight entertainment system may include games, movies and music. Typically, however, the in-flight entertainment system does not offer comprehensive information to the passenger, but rather just serves to entertain the passenger, and thus, many passengers arrive at the arrival airport without information regarding how to navigate through the arrival airport, or how to reach their destination from the arrival airport. Further, passengers may have a lack of information regarding the transportation, language, customs, and public routines of their destination.

### SUMMARY

A system for displaying at least one virtual future journey to at least one passenger onboard a mobile platform is provided. The system includes a display device that displays the at least one future journey. The system includes a source of user input coupled to the display device that enables the at least one passenger to request to view and navigate through the future journey. The display device further includes a journey futuring control module that generates the journey data that includes at least one future journey for the at least one passenger. The system further includes a graphical user interface control module that displays the at least one future journey for the at least one passenger on the display device to enable the at least one passenger to virtually experience the at least one future journey.

In one implementation, a method of providing at least one future journey for at least one passenger onboard a mobile platform is provided. The method includes providing at least one display device. The at least one display device includes at least one user input device. The method further includes receiving at least one user input from the at least one user input device requesting information regarding the at least one future journey to be taken by the at least one passenger. The method also includes determining an arrival location of the mobile platform, determining a destination of the at least one passenger after exiting the mobile platform, and displaying at least one future journey to be taken by the at least one passenger from the arrival location of the mobile platform to the destination on the display device.

The present teachings also provide an aircraft. The aircraft includes a fuselage that includes a cockpit and a passenger cabin. The passenger cabin includes at least one entertainment system for use by at least one passenger onboard the aircraft. The entertainment system includes a display and a user input device. The display is controlled by a virtual futuring control system that includes a virtual futuring control module. The virtual futuring control module outputs a future journey graphical user interface to the display based on at least one user input. The future journey graphical user interface provides a virtual simulation of at least one future journey to be taken by the at least one passenger after the at least one passenger exits the aircraft.

Also provided is a system for displaying at least one virtual future journey to at least one passenger onboard an aircraft that includes a fuselage having a cockpit and a passenger cabin. The system comprises a source of data that includes the arrival location of the aircraft, the destination of the at least one passenger, a desired means of transportation of the at least one passenger to the destination, weather conditions to be experienced by the at least one passenger on the journey to the destination, and traffic conditions to be experienced by the at least one passenger on the journey to the destination. The system also includes a source of user identification data that identifies the at least one passenger. The system further comprises at least one entertainment system for use by at least one passenger onboard the aircraft. The entertainment system includes a display and a user input device. The system includes an avatar module that determines, based on the user identification data, at least one avatar that corresponds to the at least one passenger. The system further includes a portal control module that generates portal data based on the arrival location of the aircraft and the destination data, the portal data including a three-dimensional representation of an environment. The system includes a futuring module that outputs a future journey graphical user interface to the display based on at least one user input. The future journey graphical user interface provides a virtual simulation of at least one future journey to be taken by the at least one passenger after the at least one passenger exits the aircraft. The at least one future journey simulated within the three-dimensional representation of the environment using the at least one avatar of the at least one passenger.

A method of providing at least one future journey to at least one passenger onboard a mobile platform is further provided. The method includes providing at least one display device that includes at least one user input device, and a source of transportation data that includes the transportation means of the at least one passenger to the destination. The method further includes receiving at least one user input from the at least one user input device requesting information regarding the at least one future journey to be taken by the at least one passenger. The method also comprises determining an arrival location of the aircraft, and determining a destination of the at least one passenger after exiting the aircraft. The method includes determining weather conditions to be experienced by the at least one passenger on the journey to the destination, and determining traffic conditions to be experienced by the at least one passenger on the journey to the destination. The method also includes identifying the at least one passenger requesting the future journey information, and retrieving at least one avatar based on the identification of the at least one passenger. The method includes displaying at least one future journey to be taken by the at least one passenger from the arrival location of the aircraft to the destination on the at least one display device, with the at least one future journey simulated by the at least one avatar within a three-dimensional representation of an environment.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a schematic illustration of a mobile platform incorporating the system and method for virtual journey futuring according to the principles of the present disclosure;

FIG. 2 is schematic illustration of a passenger onboard the mobile platform of FIG. 1 interfacing with an entertainment system;

FIG. 3 is a dataflow diagram illustrating an exemplary virtual futuring control system of the present disclosure;

FIG. 4 is a dataflow diagram illustrating an exemplary avatar control system of the present disclosure;

FIG. 5 is a dataflow diagram illustrating an exemplary futuring control system of the present disclosure;

FIG. 6 illustrates an exemplary future virtual journey according to the principles of the present disclosure;

FIG. 7 illustrates an exemplary future virtual journey according to the principles of the present disclosure;

FIG. 8 illustrates an exemplary future virtual journey according to the principles of the present disclosure;

FIG. 9 illustrates an exemplary future virtual journey according to the principles of the present disclosure;

FIG. 10 illustrates an exemplary future virtual journey according to the principles of the present disclosure;

FIG. 11 illustrates an exemplary future virtual journey according to the principles of the present disclosure;

FIG. 12 illustrates an exemplary future virtual journey according to the principles of the present disclosure;

FIG. 13 illustrates an exemplary future virtual journey according to the principles of the present disclosure; and

FIG. 14 is a flowchart an operational sequence for the virtual futuring control system of FIG. 3.

### DETAILED DESCRIPTION

The following description is merely exemplary in nature and is not intended to limit the present disclosure, application, or uses. Although the following description is related generally to a system and method for virtual journey futuring onboard a mobile platform (such as an aircraft, ship, spacecraft, train or land-based motor vehicle), it will be understood that the system and method for virtual journey futuring, as described and claimed herein, can be used with any appropriate application where it would be desirable for an individual to virtually experience a route they will take to reach a destination, such as a route from a hotel reservation desk to a hotel room. Therefore, it will be understood that the following discussion is not intended to limit the scope of the appended claims to only mobile platforms and mobile platform based systems.

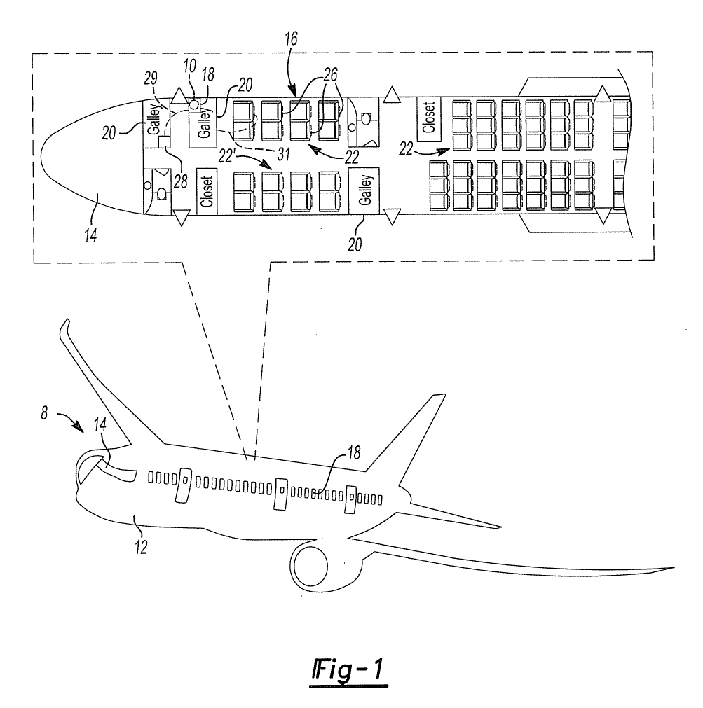

With reference to FIGS. 1 and 2, a schematic illustrates an exemplary mobile platform that employs a system and a method for virtual journey futuring through a virtual futuring control module 10. The virtual futuring control module 10 may use virtual reality to increase passenger knowledge. By being able to virtually pre-experience the parts of their journey, which are generally unfamiliar, such as locating baggage claim in the destination airport, locating transportation or locating a hotel, traveler knowledge may be increased. Through mimicking the reality that passengers expect to experience, the virtual futuring control module 10 may improve the overall travel experience for the passenger. The mobile platform, in this example, is a passenger aircraft 8 that has a fuselage 12, which includes a cockpit 14, a cabin 16 and a controller 18. The cabin 16 includes at least one crew area 20, such as a galley, at least one passenger seat 22 and an in-flight entertainment system 26.

The crew area 20 may include a control panel 28 in communication with and responsive to the controller 18. The control panel 28 can enable the crew to interface with the virtual futuring control module 10. Thus, the control panel 28 may include at least one user input device and display means, such as a GUI for example, however, any suitable user input device and display means could be employed, such as button(s), a touch screen, a mouse, a stylus and/or a display screen. As the passenger seat 22 may comprise any suitable passenger seating surface, as generally known in the art, the passenger seat 22 will not be described in great detail herein. Briefly, however, with reference to FIG. 2, the passenger seat 22 includes a seat back 22a. The in-flight entertainment system 26 may be coupled to the seat back 22a.

The in-flight entertainment system 26 may be responsive to and in communication with the controller 18 through a wired or a wireless connection (an exemplary wired connection 31 is illustrated in phantom in FIG. 1). The in-flight entertainment system 26 enables the passenger to remain occupied during the duration of the flight of the aircraft 8, as is generally known. The in-flight entertainment system 26 may include an input device 30, such as a GUI, a touch screen, a button, a touch pen, a keyboard, a joystick, a mouse or any other suitable user input device to enable the passenger to interface with the in-flight entertainment 26. With reference to FIG. 1, the controller 18 may comprise a computer and/or processor, and memory to hold instruction and data related to the virtual futuring control module 10.

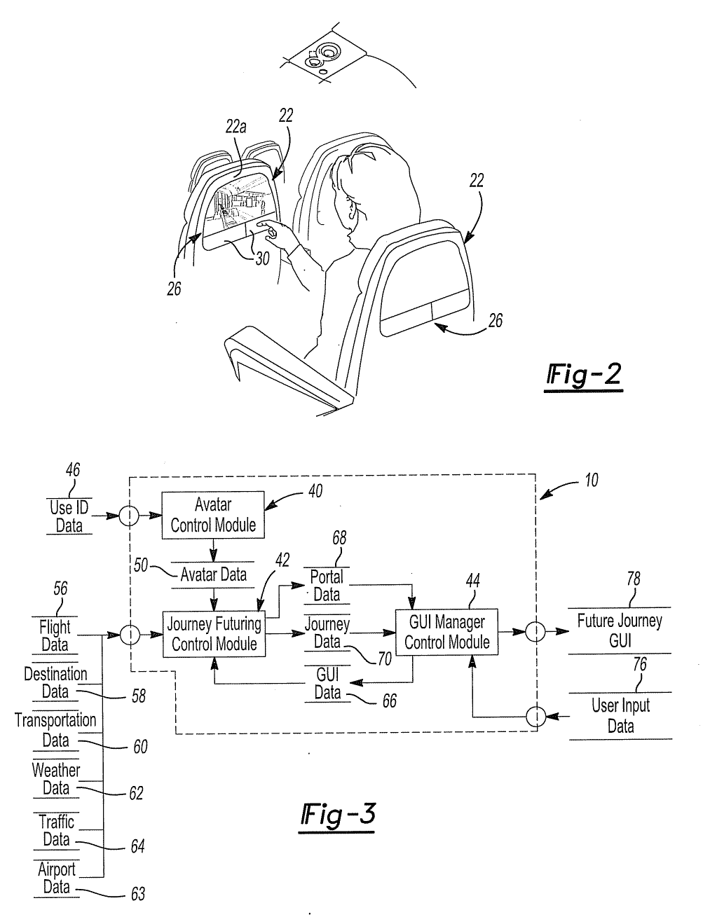

With reference to FIG. 3, the virtual futuring control module 10 for the aircraft 8 is illustrated in accordance with the teachings of the present disclosure. The virtual futuring control module 10 enables the passengers onboard the aircraft 8 to receive a virtual illustration of their upcoming journey via the in-flight entertainment 26. In this regard, the virtual futuring control module 10 operates to output at least one graphical user interface (GUI). The at least one GUI may enable the passenger to experience a journey or route of travel the passenger may need to take to reach a baggage claim in an arrival airport, a route to reach customs (if applicable), a route to reach a desired rental car counter (if applicable), public transportation (if applicable), a personal vehicle in parking lot (if applicable), and a route that may be driven to reach their destination from the rental car counter. In addition, the virtual futuring control module 10 may allow the passenger to view an instrument cluster, and other related information, such as, without limitation, how to adjust the seat, how to open the fuel tank, and fuel the car. associated with a selected rental car to enable the passenger to become familiar with the rental car prior to the operation of the rental car.

Each of these routes that are generated by the virtual futuring control module 10 may be illustrated or output to a portal that provides, via the in-flight entertainment system 26, a three-dimensional graphical representation of the arrival airport, arrival city and arrival county, such as portals generated through the user in SECOND LIFE™ (manufactured by Linden Labs of San Francisco, Calif.) or a default portal, for example, GOOGLE EARTH™ (manufactured by Google, Inc. of Mountain View, Calif.). Thus, the virtual futuring control module 10 may serve to increase passenger knowledge prior to the passenger arriving in a new location by enabling the passenger, through the in-flight entertainment system 26, to virtually experience the routes or path of travel they will need to take to reach their destination once the passenger has exited the aircraft 8.

In addition, the virtual futuring control module 10 may provide new opportunities for marketing. Much like in SECOND LIFE™ (manufactured by Linden Labs of San Francisco, Calif.), the virtual environment generated by the virtual futuring control module 10 may provide an additional canvas for companies to market their products or services. This marketing revenue may be generated by the companies purchasing virtual space, such as virtual billboards, virtual stores and the like, or passengers could pay for the absence of advertising in their virtual space.

As used herein, the term “module” refers to an application specific integrated circuit (ASIC), an electronic circuit, a processor (shared, dedicated, or group) and memory that executes one or more software or firmware programs, to a combinational logic circuit, and/or to other suitable components that provide the described functionality. In FIG. 3, a dataflow diagram illustrates various components of a virtual futuring control system that is embedded within the virtual futuring control module 10. Various embodiments of the virtual futuring control module 10 may include any number of sub-modules embedded within the virtual futuring control module 10. The sub-modules shown in FIG. 3 may be combined and/or further partitioned to similarly control the virtual information of the passengers onboard the aircraft 8. Inputs to the virtual futuring control module 10 are received from other control modules (not shown) within the aircraft 8, and/or determined by other sub-modules (not shown) within the virtual futuring control module 10 (not shown). In FIG. 3, the virtual futuring control module 10 includes an avatar control module 40, a journey futuring control module 42, and a graphical user interface (GUI) manager control module 44.

The avatar control module 40 receives as input user identification (ID) data 46. The user ID data 46 comprises at least a name of the passenger and the passenger seat 22 assigned to the passenger. In addition, the user ID data 46 may comprise data regarding the destination of the passenger, the departure time of the passenger's flight, a native language of the passenger and if the passenger requires assistance while traveling. The user ID data 46 may be received by a passenger list provided by an airline, may be received based from input to the in-flight entertainment system 26 via the user input device 30 or may be received from user data stored on a ground server (not specifically shown). Based on the user ID data 46, the avatar control module 40 sets avatar data 50 for the journey futuring control module 42. The avatar data 50 comprises a desired look for an avatar of the passenger to be displayed on the in-flight entertainment system 26 to simulate the passenger traveling the virtual journey or route. As avatars are generally known in the art, avatars will not be discussed in great detail herein. Briefly, however, the avatar may comprise a pre-selected graphical representation of the passenger that may be used to simulate the passenger virtually interacting with the virtual futuring control module 10, such as virtually traveling on the future journey, as will be discussed herein. Exemplary programs for creating avatars may include Playstation Home (manufactured by Sony Computer Entertainment America, Inc. of Foster City, Calif.), SECOND LIFE™ (manufactured by Linden Labs of San Francisco, Calif.) or THERE™ (manufactured by Makena Technologies, Inc. of Silicon Valley, Calif.).

With reference to FIG. 4, a dataflow diagram illustrates an exemplary avatar control system that may be embedded within the avatar control module 40. The avatar control module 40 includes an avatar module 52 and an avatar data store 54. The avatar module 52 receives as input the user ID data 46 and the avatar data 50. The avatar data 50 comprises a pre-selected avatar for the passenger. Based on the user ID data 46, the avatar module 52 may identify if that passenger has a pre-selected avatar. The avatar module 52 can determine if a passenger has a pre-selected avatar by querying the avatar data store 54 for the avatar data 50 that corresponds with the user ID data 46. The avatar data store 54 may comprise one or more data storage devices and may be at least one of random access memory (RAM), read only memory (ROM), a cache, a stack, or the like which may temporarily or permanently store electronic data. The avatar data store 54 stores electronic data associated with the pre-selected avatars for the passenger and optionally, a default avatar. Based on the user ID data 46, the avatar module 52 outputs the avatar data 50, which comprises the pre-selected avatar for the passenger, or alternatively, a default avatar. Alternatively, the avatar data 50 may be obtained from a portable storage device (not shown) provided by the passenger.

With reference back to FIG. 3, the journey futuring control module 42 receives as input the avatar data 50, flight data 56, destination data 58, transportation data 60, weather data 62, traffic data 64, airport data 63 and GUI data 66. The avatar data 50 is received from the avatar control module 40, as discussed herein. The flight data 56 comprises a route or planned flight of travel for the aircraft 8, and includes landing information (time, arrival location or arrival airport), terminal assignment and gate assignment. The flight data 56 may be updated to correspond to changes in the flight data 56. The destination data 58 comprises data regarding the passenger's destination, such as a hotel, residence, hostel, etc. The destination data 58 may be provided via a user input to the in-flight entertainment system 26 through the user input device 30, or may be provided by a travel service used by the passenger.

The transportation data 60 comprises data regarding the passenger's transportation from the airport to the passenger's destination, such as a location of a desired rental car counter, a location of mass transportation (i.e. subway, busses, etc), a location of transportation for hire (i.e. limos, taxies, etc.), etc. The transportation data 60 may also include a layout of the instrument cluster of the rental car. The transportation data 60 may be provided via a user input to the in-flight entertainment system 26 through the user input device 30, or may be provided by a travel service used by the passenger. The weather data 62 comprises weather conditions that the passenger will encounter on the passenger's journey or route from the arrival airport to the passenger's destination. The weather data 62 may be received from a national weather service provider, such as weather content from The Weather Channel Interactive, Inc. of Atlanta, Ga. The traffic data 64 comprises traffic conditions that the passenger will encounter on the passenger's journey or route from the arrival airport to the passenger's destination, and may include local traffic, construction, driving laws, pedestrian laws, a description of the meaning of traffic signs if they are in another language, a description of traffic light laws, and the like. The traffic data 64 may be received from a suitable traffic provider, such as NAVTEQ of Chicago, Ill. or the U.S. Department of Transportation of Washington, D.C. It should be noted that international traffic data 64 may be acquired from a comparable source. The airport data 63 comprises data regarding the destination or arrival airport associated with the passenger's journey, and can include a layout of the airport, such as the location of the gates, terminal layouts, baggage claim locations, rental car counter locations, etc. The GUI data 66 may comprise a user input to the GUI manager control module 44 made via the user input device 30, as will be discussed herein.

Based on the avatar data 50, flight data 56, destination data 58, transportation data 60, weather data 62, traffic data 64, airport data 63 and GUI data 66, the journey futuring control module 42 sets portal data 68 and journey data 70 for the GUI manager control module 44. The portal data 68 comprises a desired portal to display the virtual representation of the passenger's journey from deplaning the aircraft 8 to arriving at the passenger's destination. In this regard, the portal data 68 comprises a three-dimensional representation of the environment the passenger will traverse in the passenger's virtual journey, such as the airport, city streets, and destination hotel. Thus, the portal data 68 may comprise landscapes, street information, building layouts (including airports, hotels etc), and may be acquired from any exemplary source that has already generated or created this content. For example, the portal data 68 may comprise a SECOND LIFE™ (manufactured by Linden Labs of San Francisco, Calif.) based portal, a GOOGLE EARTH™ (manufactured by Google, Inc. of Mountain View, Calif.) based portal, or a VIRTUAL EARTH™ (manufactured by Microsoft, Inc. of Redmond, Wash.) based portal. The journey data 70 comprises data associated with the journey or route the passenger will take from deplaning the aircraft 8 to arriving at the passenger's destination. Thus, the journey data 70 may comprise data related to a graphical representation of the passenger's avatar from the avatar data 50 traveling a route from the assigned gate, through the terminal, to the baggage claim, to a rental car counter, into a rental car, through a geographic area, such as one or more city streets, until the passenger arrives at the passenger's destination. It will be understood, however, that these are merely examples of the routes the journey data 70 could provide, other examples include a route to a local tourist destination, a route to a local attraction, a route to a local activity, a route to a local sporting event, etc.

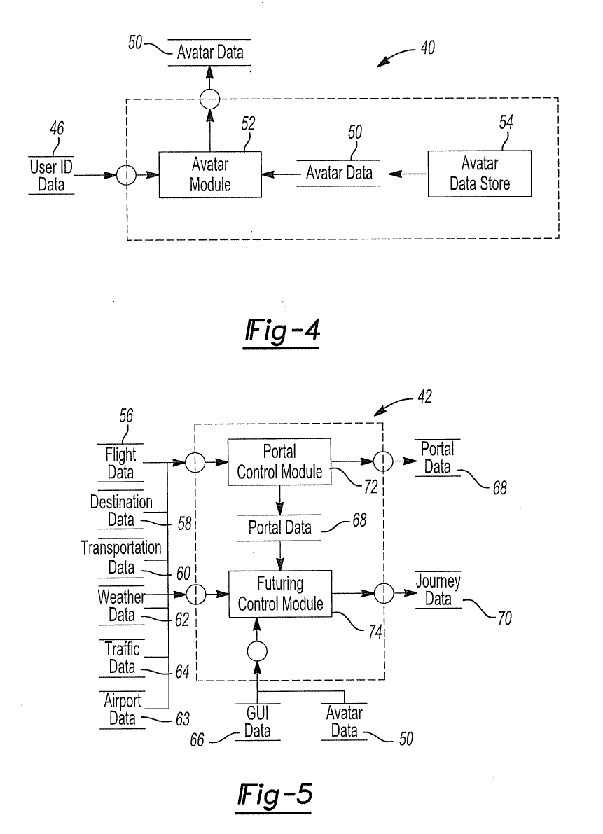

With reference to FIG. 5, a dataflow diagram illustrates an exemplary futuring control system that may be embedded within the journey futuring control module 42. The journey futuring control module 42 comprises a portal control module 72 and a futuring control module 74. The portal control module 72 receives as input the flight data 56 and the destination data 58. Based on the flight data 56 and destination data 58, the portal control module 72 outputs the portal data 68 and sets the portal data 68 for the futuring control module 74. The portal data 68 provides the appropriate landscapes and layouts given the flight data 56 and destination data 58.

The futuring control module 74 receives as input the portal data 68, the flight data 56, the destination data 58, the transportation data 60, the weather data 62, the traffic data 64, airport data 63 and the GUI data 66. Based on the portal data 68, the flight data 56, the destination data 58, the transportation data 60, the weather data 62, the traffic data 64, airport data 63 and the GUI data 66, the futuring control module 74 outputs the journey data 70 for display in the portal selected in the portal data 68.

With reference to FIG. 3, the GUI manager control module 44 receives as input portal data 68, journey data 70, user input data 76. The user input data 76 is received from the user input device 30 (FIG. 2) coupled to the in-flight entertainment system 26 (FIG. 2) and comprises a request from the passenger to virtually view the passenger's future journey. Based on the user input data 76, the GUI manager control module 44 sets GUI data 66 for the journey futuring control module 42.

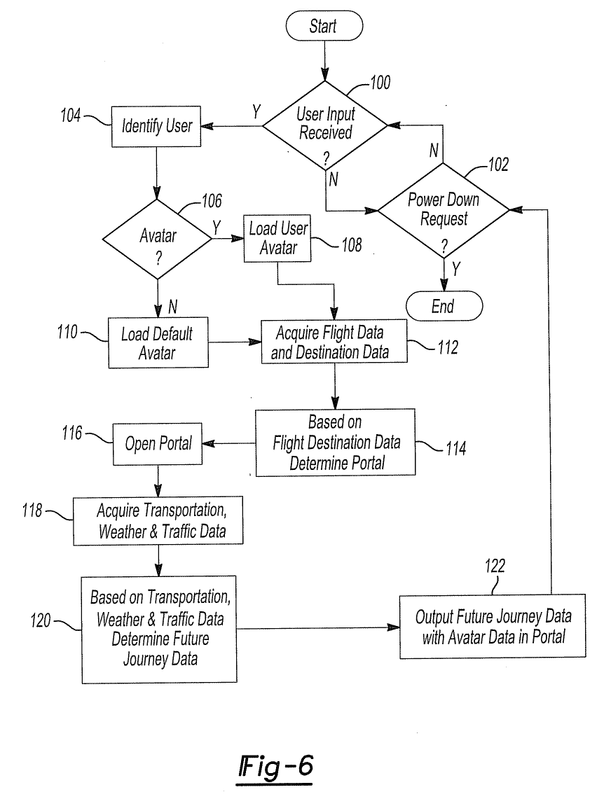

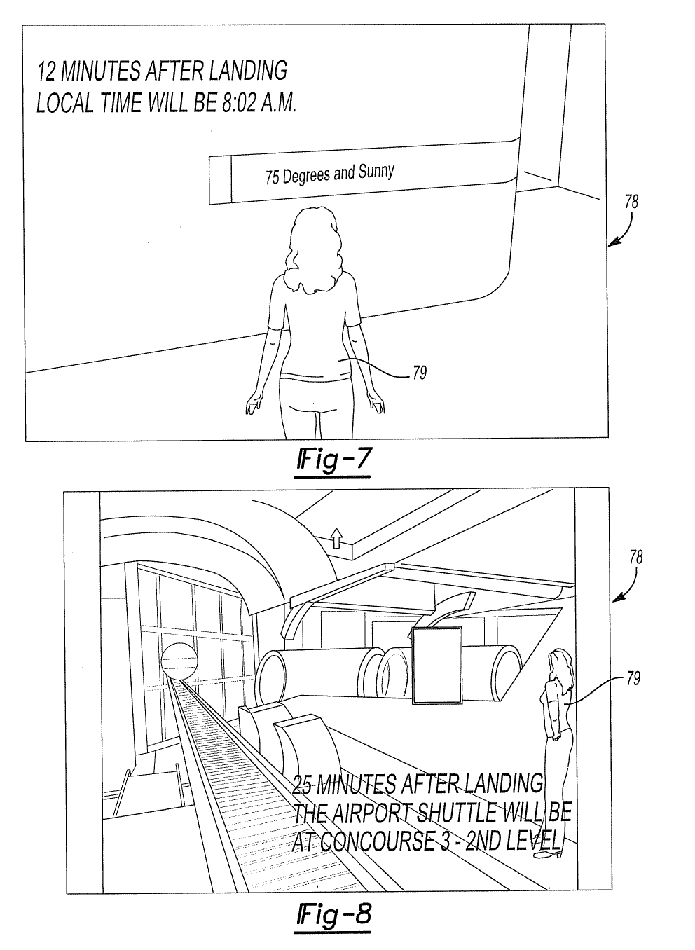

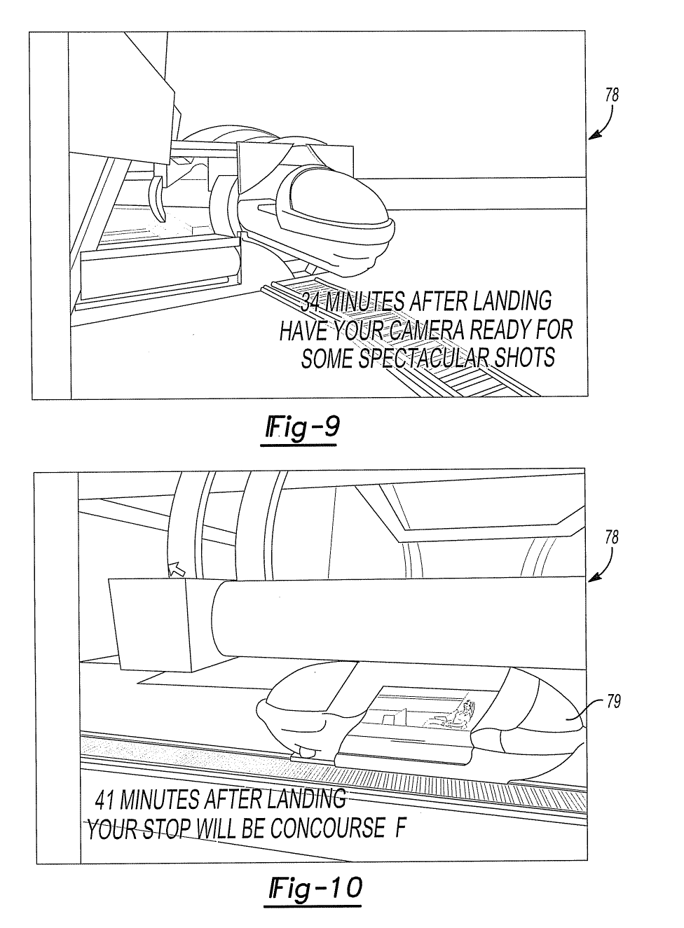

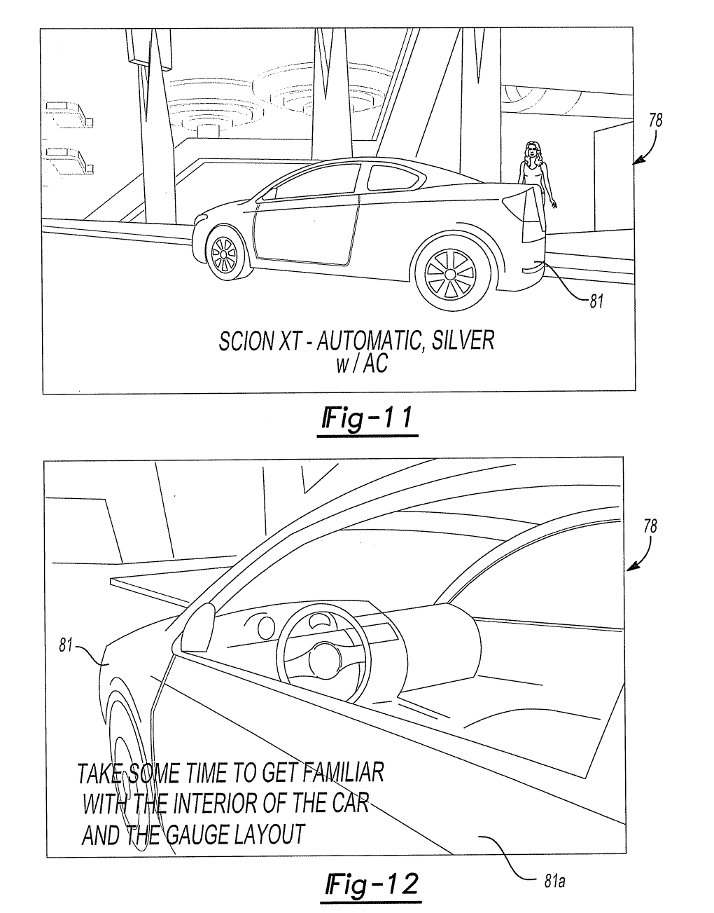

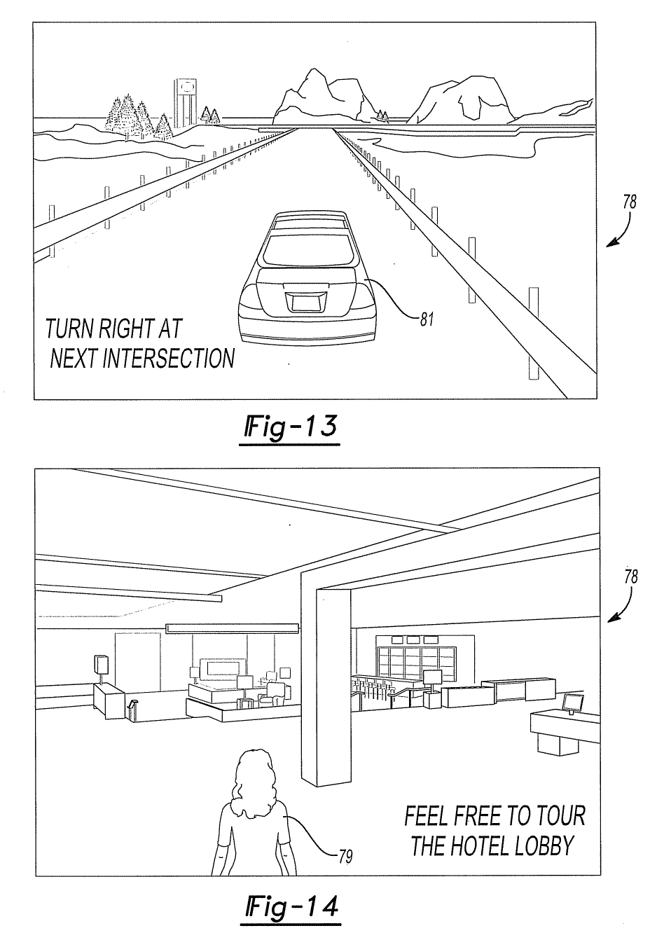

Based on the portal data 68 and the journey data 70, the GUI manager control module 44 outputs a future journey GUI 78. The future journey GUI 78 comprises a graphical representation of the passenger, via the avatar, traveling on the passenger's future journey in either a SECOND LIFE™ (manufactured by Linden Labs of San Francisco, Calif.) generated world view or a global world view provided by GOOGLE EARTH™ (manufactured by Google, Inc. of Mountain View, Calif.) or a VIRTUAL EARTH™ (manufactured by Microsoft, Inc. of Redmond, Wash.) based portal. Thus, the future journey GUI 78 provides the passenger onboard the aircraft 8 with a virtual simulation of at least one future journey to be taken by the passenger after the passenger exits the aircraft 8, as shown in FIG. 6. In FIG. 6, the future journey GUI 78 is illustrated with an avatar 79 that shows the passenger after the passenger has exited the aircraft 8. Further, with reference to FIGS. 7-9, the future journey GUI 78 illustrates with the avatar 79 a future journey from the aircraft 8 to a baggage claim. FIG. 10 illustrates the future journey GUI 78 which shows a journey from the baggage claim to a transportation means, such as a rental car 81. FIG. 11 illustrates the future journey GUI 78 providing the passenger with an illustration of an instrument cluster 81a in the rental car 81. FIG. 12 illustrates the future journey GUI 78 showing a journey the passenger may take via the transportation means (i.e. the rental car 81) to a destination. FIG. 13 shows the future journey GUI 78 illustrating the avatar 79 at the destination, such as a lobby of a hotel.

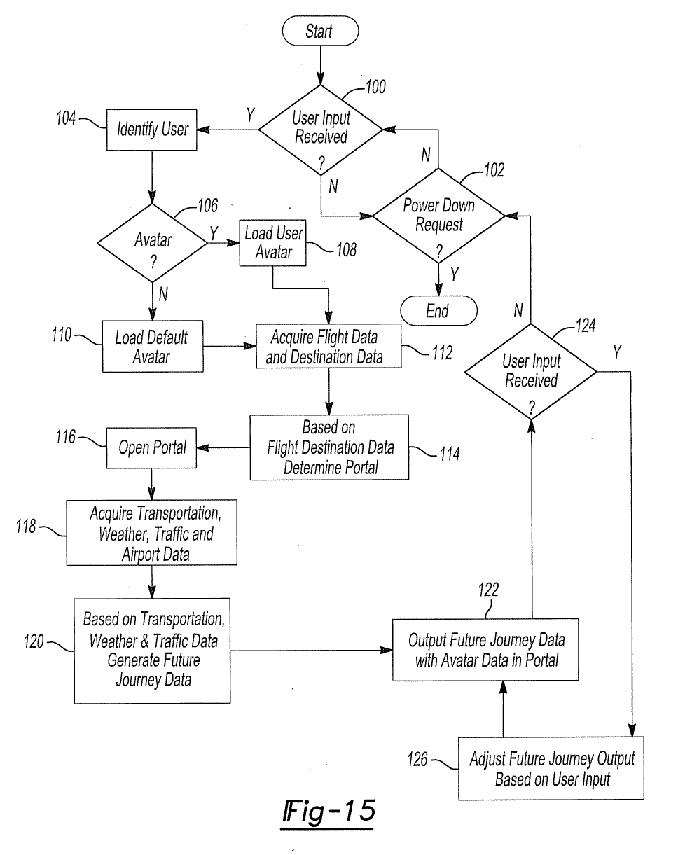

With reference to FIG. 14, a process flow diagram illustrates an exemplary operational sequence performed by the virtual futuring control module 10. At operation 100, the method recognizes a user input. The user input may comprise user input data 76, which is received from the user input device 30 (FIG. 2) coupled to the in-flight entertainment system 26 (FIG. 2). At operation 102, the method determines if a power down request has been received. If a power down request has been received, then the method ends.

Once the user input is received, the method goes to operation 104. At operation 104, the method identifies the passenger based on the user ID data 46. Then, at operation 106, the method determines if the passenger has a pre-selected avatar stored in the avatar data store 54. If the passenger has a pre-selected avatar, then the method loads the passenger's pre-selected or pre-stored avatar at operation 108. Otherwise, the method loads a default avatar at operation 110.

At operation 112, the method acquires the flight data 56 and the destination data 58 associated with the aircraft 8. As discussed, the flight data 56 may be provided by an airline operating the aircraft 8, and the destination data 58 may be provided by the passenger through the user input device 30, or may be provided by a travel service used by the passenger. At operation 114, based on the flight data 56 and the destination data 58, the method determines the portal on which the journey data 70 will be displayed, and generates the portal data 68. At operation 116, the method opens the portal or sets portal data 68 (FIG. 3) for the GUI manager control module 44.

At operation 118, the method acquires the transportation data 60, the weather data 62, the traffic data 64, and airport data 63. Then, at operation 120, based on the transportation data 60, the weather data 62, the traffic data 64, and the airport data 63 (FIG. 3), the method generates the journey data 70. At operation 122, the method outputs the future journey GUI 78, which includes the avatar data 50 and the portal data 68. Thus, the future journey GUI 78 may include the avatar displayed on the in-flight entertainment system 26, in the selected portal, so that the passenger may watch their impending or future journey he/she will travel from deplaning at the arrival airport to arriving at the destination as shown in FIGS. 6-13. In addition, the passenger may save the future journey GUI 78 on a portable storage device (not shown) if desired. After outputting the future journey GUI 78, the method goes to operation 124.

In operation 124, the method determines if a user input has been received from the user input device 30 (FIG. 2). The user input may comprise a request to stop, rewind, fast forward, pause/play, skip forward, skip back or otherwise manipulate the display of the future journey GUI 78. It should be noted that although selectors or other specific user input devices are not illustrated on the in-flight entertainment system 26, specific selectors or user input devices could be displayed on the future journey GUI 78, or could be incorporated on the user input device 30 of the in-flight entertainment system 26. If a user input has been received in operation 124, then the method adjusts the future journey GUI 78 to correspond to the user input in operation 126, and the method goes to operation 122. Otherwise, the method loops to operation 102.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this disclosure, but that the scope of the present disclosure will include any embodiments falling within the foregoing description and the appended claims.

What is claimed is:

1. A system for displaying at least one virtual future journey to at least one passenger onboard a mobile platform comprising:
a display device that displays the at least one future journey;
a source of user input coupled to the display device that enables the at least one passenger to request to view the at least one future journey;
a journey futuring control module that generates the journey data that includes at least one future journey for the at least one passenger; and
a graphical user interface control module that displays the at least one future journey for the at least one passenger on the display device to enable the at least one passenger to virtually experience the at least one future journey for the at least one passenger.

2. The system claim 1, wherein the at least one future journey selected from the group comprising: a journey from an arrival location of the mobile platform to a baggage claim, a journey from the baggage claim to a transportation means, a journey via the transportation means to a destination, and combinations thereof

3. The system of claim 2, wherein the journey futuring control module further comprises:
a source of data that includes the arrival location of the mobile platform;
a source of destination data that includes the destination of the at least one passenger; and
a portal control module that generates portal data that includes a three-dimensional environment for the display of the journey data.

4. The system of claim 3, wherein the journey futuring control module further comprises:
a source of transportation data that includes a desired means of transportation of the at least one passenger to the destination;
a source of weather data that includes weather conditions to be experienced by the at least one passenger on the journey to the destination;
a source of traffic data that includes traffic conditions to be experienced by the at least one passenger on the journey to the destination; and
a futuring control module that generates the journey data based on the arrival location, destination data, transportation data, weather data and traffic data.

5. The system of claim 4, further comprising:
a source of user identification data that includes an identifier associated with the at least one passenger that requests the information;
an avatar database that stores data that includes pre-selected avatars for the at least one passenger; and
an avatar module that determines, based on the user identification data, which of the pre-selected avatars corresponds to the at least one passenger.

6. The system of claim 3, wherein the mobile platform comprises an aircraft and the arrival location includes at least an arrival airport for the aircraft, a terminal assignment at the arrival airport for the aircraft, a gate assignment at the arrival airport for the aircraft or combinations thereof.

7. The system of claim 5, wherein the graphical user interface control module displays the pre-selected avatar associated with the at least one passenger traveling on the at least one future journey.

8. The system of claim 2, wherein the display device comprises an entertainment system coupled to at least one passenger seat onboard the mobile platform.

9. A method of providing at least one future journey to at least one passenger onboard a mobile platform comprising:
providing at least one display device that includes at least one user input device;
receiving at least one user input from the at least one user input device requesting information regarding the at least one future journey to be taken by the at least one passenger;
determining an arrival location of the mobile platform;
determining a destination of the at least one passenger after exiting the mobile platform; and
displaying at least one future journey to be taken by the at least one passenger from the arrival location of the mobile platform to the destination on the at least one display device

10. The method of claim 9, wherein displaying at least one future journey further comprises at least one of:
displaying a future journey from an arrival location of the mobile platform to a baggage claim;
displaying a future journey from the baggage claim to a transportation means;
displaying a future journey via the transportation means to a destination; and
combinations thereof.

11. The method of claim 9, further comprising:
displaying the at least one future journey in a portal such that the at least one future journey is displayed within a three-dimensional representation of an environment.

12. The method of claim 10, further comprising:
providing a source of transportation data that includes the transportation means of the at least one passenger to the destination;
determining weather conditions to be experienced by the at least one passenger on the journey to the destination;
determining traffic conditions to be experienced by the at least one passenger on the journey to the destination; and
displaying the at least one future journey based on the arrival location of the mobile platform, the destination, the transportation data, the weather conditions and the traffic conditions.

13. The method of claim 11, further comprising:
providing an avatar database that stores data that includes pre-selected avatars for the at least one passenger;
identifying the at least one passenger requesting the future journey information;
determining if the at least one passenger has a stored pre-selected avatar; and
determining, based on the identification of the at least one passenger, which of the pre-selected avatars corresponds to the at least one passenger.

14. The method of claim 13, further comprising:
displaying the pre-selected avatar traveling the at least one future journey in the three-dimensional environment.

15. The method of claim 9, further comprising:
providing at least one passenger seat within a cabin of the mobile platform for receipt of the at least one passenger; and
coupling the at least one display device to the at least one passenger seat to enable the at least one passenger to view the at least one future journey displayed on the at least one display device.

16. An aircraft comprising:
a fuselage that includes a cockpit and a passenger cabin, the passenger cabin including at least one entertainment system for use by at least one passenger onboard the aircraft, the entertainment system including a display and a user input device, with the display controlled by a virtual futuring control system including:
a virtual futuring control module that outputs a future journey graphical user interface to the display based on at least one user input, the future journey graphical user interface providing a virtual simulation of at least one future journey to be taken by the at least one passenger after the at least one passenger exits the aircraft.

17. The aircraft of claim 16, wherein the virtual futuring control module further comprises:
a source of data that includes the arrival location of the mobile platform;
a source of destination data that includes the destination of the at least one passenger; and
a portal control module that generates portal data based on the arrival location of the mobile platform and the destination data, the portal data including a three-dimensional environment for the display of the journey data.

18. The aircraft of claim 17, wherein the virtual futuring control module further comprises:
a source of transportation data that includes a desired means of transportation of the at least one passenger to the destination;
a source of weather data that includes weather conditions to be experienced by the at least one passenger on the journey to the destination;
a source of traffic data that includes traffic conditions to be experienced by the at least one passenger on the journey to the destination; and
a futuring control module that generates the journey data based on the arrival location, destination data, transportation data, weather data and traffic data.

19. The aircraft of claim 18, wherein the virtual futuring control module further comprises:
a source of user identification data that includes an identifier associated with the at least one passenger that requests the information;
an avatar database that stores data that includes pre-selected avatars for the at least one passenger; and
an avatar module that determines, based on the user identification data, which of the pre-selected avatars corresponds to the at least one passenger.

20. The aircraft of claim 19, wherein the virtual futuring control module outputs the pre-selected avatar associated with the at least one passenger traveling on the at least one future journey to the display with the future journey graphical user interface.

21. The aircraft of claim 16, wherein the at least one future journey is selected from the group comprising: a journey from an arrival location of the aircraft to a baggage claim, a journey from the baggage claim to a transportation means, a journey via the transportation means to a destination, and combinations thereof.

22. A system for displaying at least one virtual future journey to at least one passenger onboard an aircraft that includes a fuselage having a cockpit and a passenger cabin comprising:
a source of data that includes the arrival location of the aircraft, the destination of the at least one passenger, a desired means of transportation of the at least one passenger to the destination, weather conditions to be experienced by the at least one passenger on the journey to the destination, and traffic conditions to be experienced by the at least one passenger on the journey to the destination;
a source of user identification data that identifies the at least one passenger;
at least one entertainment system for use by at least one passenger onboard the aircraft, the entertainment system including a display and a user input device;
an avatar module that determines, based on the user identification data, at least one avatar that corresponds to the at least one passenger;
a portal control module that generates portal data based on the arrival location of the aircraft and the destination data, the portal data including a three-dimensional representation of an environment; and
a futuring module that outputs a future journey graphical user interface to the display based on at least one user input, the future journey graphical user interface providing a virtual simulation of at least one future journey to be taken by the at least one passenger after the at least one passenger exits the aircraft, with the at least one future journey simulated within the three-dimensional representation of the environment using the at least one avatar of the at least one passenger.

23. A method of providing at least one future journey to at least one passenger onboard a mobile platform comprising:
providing at least one display device that includes at least one user input device, and a source of transportation data that includes the transportation means of the at least one passenger to the destination;
receiving at least one user input from the at least one user input device requesting information regarding the at least one future journey to be taken by the at least one passenger;
determining an arrival location of the mobile platform;
determining a destination of the at least one passenger after exiting the mobile platform;
determining weather conditions to be experienced by the at least one passenger on the journey to the destination;
determining traffic conditions to be experienced by the at least one passenger on the journey to the destination;
identifying the at least one passenger requesting the future journey information;
retrieving at least one avatar based on the identification of the at least one passenger; and
displaying at least one future journey to be taken by the at least one passenger from the arrival location of the aircraft to the destination on the at least one display device, with the at least one future journey simulated by the at least one avatar within a three-dimensional representation of an environment.
